(19) United States
(12) Patent Application Publication
(10) Pub. No.: US 2026/0316760 A1
(43) Pub. Date: Oct. 15, 2026

(54) A Method and Device for Automatic Lane Changing of Vehicles

(71) Applicant: Robert Bosch GmbH, Stuttgart (DE)

(72) Inventors: Yongming Pan, Jiangsu (CN); Jianjun Wang, Jiangsu (CN); Jin Yan, Jiangsu (CN); Shaobo Liu, Jiangsu (CN)

(21) Appl. No.: 19/476,609

(22) PCT Filed: Apr. 8, 2024
(86) PCT No.: PCT/EP2024/059444

§ 371 Date: Oct. 17, 2025

(30) Foreign Application Priority Data
Apr. 18, 2023 (CN) 202310416838.8

(51) Int. Cl. B60W 30/18; B60W 50/00; B60W 50/14

(52) U.S. Cl. CPC B60W 30/18163; B60W 50/14; B60W 2050/0011; B60W 2510/202; B60W 2520/06; B60W 2540/30; B60W 2552/10

(57) ABSTRACT

A method for automatic lane changing of vehicles including (i) receiving scenario information, (ii) receiving lane change recommendations, and (iii) adjusting one or more parameters of the PID controller based on the scenario information and the lane change recommendations to mimic the driving style of the driver during lane changes. A device for automatic lane changing of vehicles, a computer storage medium, and a computer program product are also disclosed.

### TECHNICAL FIELD

The present application relates to the field of vehicle control, and specifically, to a method for automatic lane changing of vehicles, a device for automatic lane changing of vehicles, and a computer storage medium.

### BACKGROUND ART

Currently, the basic steps of an automatic (assisted) lane changing/switching system are trajectory planning and control. The system will plan a trajectory line from the center of the vehicle (usually the center point of the rear axle) to the center of the target adjacent lane (referred to as trajectory planning), and then use a controller with a set of control parameters (e.g. a PID controller or LQR controller) to formulate a way to make sure that the vehicle travels along the planned trajectory (referred to as control).

However, all existing lane changing systems control the entry of a vehicle into adjacent lanes with the same set of control parameters and a relatively fixed trajectory. This means that regardless of who drives the vehicle, under the same circumstances, the vehicle will have the same control trajectory and the same control parameters. In other words, for different drivers, the driving style and driving experience will be the same for different drivers. However, each driver has their own driving habits and driving style. For example, some drivers prefer a gentle lane changing style, while others prefer the fastest possible lane changing style.

Therefore, it is desirable to have an improved automatic lane changing solution that takes into account the driving habits and driving style of a specific driver.

### SUMMARY OF THE INVENTION

According to one aspect of the present application, a method for automatic lane changing of vehicles is provided, wherein the method comprises: receiving scenario information; receiving lane change recommendations; and adjusting one or more parameters of the PID controller based on the scenario information and the lane change recommendations to mimic the driving style of the driver during lane changes.

As a supplement or alternative to the above solution, in the above method, the lane change recommendations instruct the use of specific driver lane change samples based on the scenario information.

As a supplement or alternative to the above solution, in the above method, the driver lane change samples record the driver's steering wheel torque and the associated lateral distance Dy value for each cycle during the vehicle's lane change process.

As a supplement or alternative to the above solution, in the above method, the scenario information is indicated at least by a wiper signal.

As a supplement or alternative to the above solution, in the above method, adjusting one or more parameters of the PID controller based on the scenario information and the lane change recommendations to mimic the driving style of the driver during lane changes comprises: determining specific driver lane change samples based on the scenario information and the lane change recommendations; calculating the parameter set of the lateral distance Dy error controller in the PID controller based on the specific lane change samples; and using the lateral distance Dy error controller to determine the required steering wheel torque based on the currently measured lateral distance Dy value.

As a supplement or alternative to the above solution, in the above method, adjusting one or more parameters of the PID controller based on the scenario information and the lane change recommendations to mimic the driving style of the driver during lane changes further comprises: utilizing the heading angle error controller in the PID controller to determine the required heading angle based on the currently measured heading angle.

As a supplement or alternative to the above solution, in the above method, the parameter set of the lateral distance Dy error controller comprises an adjustment factor for the proportional coefficient Kₚ of the PID controller, with the adjustment factor related to the lateral distance Dy.

As a supplement or alternative to the above solution, in the above method, using the lateral distance Dy error controller to determine the required steering wheel torque based on the currently measured lateral distance Dy value comprises:

$$T = σ * {K}_{p} * Δ Dy + {K}_{i} * \int Δ Dy dt + {K}_{d} * \frac{Δ Dy}{dt} ,$$

wherein T represents the steering wheel torque, σ is the adjustment factor of the proportional coefficient Kₚ, Kᵢ is the integration coefficient of the PID controller, and K_{d} is the differential coefficient of the PID controller.

According to one aspect of the present application, a device for automatic lane changing of vehicles is provided, wherein the method comprises: a scenario analysis module for determining scenario information; a lane change recommendation module for providing lane change recommendations; an adaptive PID control module for adjusting one or more parameters of the PID control module based on the scenario information and the lane change recommendations to mimic the driving style of the driver during lane changes.

As a supplement or alternative to the above solution, in the above device, the lane change recommendations instruct the use of specific driver lane change samples based on the scenario information, and the driver lane change samples record the driver's steering wheel torque and the associated lateral distance Dy value for each cycle during the vehicle's lane change process.

As a supplement or alternative to the above solution, in the above device, the scenario information is indicated at least by a wiper signal.

As a supplement or alternative to the above solution, in the above device, the adaptive PID control module is configured to determine specific driver lane change samples based on the scenario information and the lane change recommendations, and the adaptive PID control module further comprises: a lateral distance Dy error control module used to calculate the parameter set thereof based on the specific driver lane change samples and to determine the required steering wheel torque based on the currently measured lateral distance Dy value.

As a supplement or alternative to the above solution, in the above device, the adaptive PID control module further comprises: a heading angle error control module used to determine the required heading angle based on the currently measured heading angle.

As a supplement or alternative to the above solution, in the above device, the parameter set of the lateral distance Dy error control module comprises an adjustment factor for the proportional coefficient Kₚ of the adaptive PID control module, with the adjustment factor related to the lateral distance Dy, and the lateral distance Dy error control module is configured to determine the required steering wheel torque T based on the following formula:

$$T = σ * {K}_{p} * Δ Dy + {K}_{i} * \int Δ Dy dt + {K}_{d} * \frac{Δ Dy}{dt} ,$$

wherein σ is the adjustment factor of the proportional coefficient Kₚ, Kᵢ is the integration coefficient of the adaptive PID control module, and K_{d} is the differential coefficient of the adaptive PID control module.

According to yet another aspect of the present application, a computer storage medium is provided comprising instructions that, when executed, perform the control method for a motor system as described above.

According to yet another aspect of the present application, a computer program product comprising a computer program, which, when executed by a processor, performs the above method.

The inventors of the present application are aware of the following: when a person is driving a vehicle, they not care about trajectory planning or controllers; their only concern is to guide the vehicle to the center of the target lane through the output and the steering torque they exert on the steering wheel (also known as steering wheel torque). During this process, they will constantly observe the lateral offset of the target line (also known as Dy) and the heading angle of the target line for assistance. Different torques at different Dy points reflect their driving style. The driver observes the heading angle to maintain the correct driving direction.

Therefore, based on the scenario information and lane change recommendations, the automatic lane changing solution for vehicles of the examples of the present application involves adjusting one or more parameters of the PID controller to mimic the driver's driving style during lane changes, such that the entire vehicle lane change process appears more human-controlled (i.e., performed under the control of the current driver), which enhances the comfort of vehicle driving. The solution does not require complex algorithms to plan a trajectory. The only target trajectory is the centerline of the target lane.

The automatic lane changing solution for vehicles of the examples of the present application analyzes the driver's steering wheel torque and then calculates a set of PID control parameters based on Dy to ensure that the system control provides a driving experience consistent with that under the owner's control. In one or more examples, the PID controller has learning and adaptive capabilities. Such a PID mechanism makes it possible to dynamically change the PID control parameters, making it more like a human-controlled PID control system.

### DESCRIPTION OF ACCOMPANYING DRAWINGS

The foregoing and other objectives and advantages of the present application will become more fully apparent from the following detailed description taken in conjunction with the accompanying drawings, in which identical or similar elements are denoted by the same reference numerals.

FIG. 1 shows a schematic flowchart of a method for automatic lane changing of vehicles according to one example of the present application;

FIG. 2 shows a structural schematic diagram of a device for automatic lane changing of vehicles according to one example of the present application;

FIG. 3 shows a schematic diagram of the interaction between the various modules of the device for automatic lane changing of vehicles according to one example of the present application;

FIG. 4 shows a schematic diagram of a driver lane change sample according to one example of the present application;

### SPECIFIC EMBODIMENTS

In the following, an automatic lane changing solution for vehicles according to various exemplary examples of the present application will be described in detail with reference to the accompanying drawings.

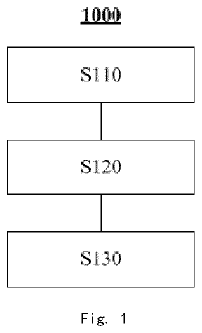

FIG. 1 shows a schematic flowchart of a method 1000 for automatic lane changing of vehicles according to one example of the present application.

As shown in FIG. 1, the method 1000 for automatic lane changing of vehicles comprises the following steps:
in step S110, receiving scenario information;
in step S120, receiving lane change recommendations; and
in step S130, adjusting one or more parameters of the PID controller based on the scenario information and the lane change recommendations to mimic the driving style of the driver during lane changes.

In the context of the present application, “scenario information” is used to indicate the driving scenario in which the current vehicle is located. For example, when it is raining, a driver will change lanes differently than on a sunny day. Therefore, the wiper signal may be used as scenario information to adjust one or more parameters of the PID controller. In addition to weather, scenario information may further comprise: vehicle speed, lane radius and lane width. In one example, scenario information is indicated by a combination of wiper signal, wheel speed signal, and related information detected by other sensors.

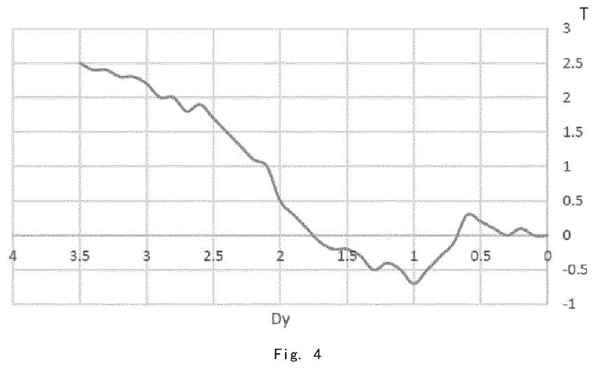

The term “lane change recommendations” is used to indicate the use of specific driver lane change samples in a scenario. “Driver lane change samples” refer to driving information collected during the vehicle's lane change process. In one example, the driver lane change samples may be as shown in FIG. 4, which record the driver's steering wheel torque and the associated lateral distance Dy value (i.e., the lateral distance from the centerline of the adjacent lane that the vehicle is leaving (or changing to)) for each cycle during the vehicle's lane change process.

in step S130, adjusting one or more parameters of the PID controller based on the scenario information and the lane change recommendations to mimic the driving style of the driver during lane changes. In one example, step S130 comprises: determining specific driver lane change samples based on the scenario information and the lane change recommendations; calculating the parameter set of the lateral distance Dy error controller in the PID controller based on the specific lane change samples; and using the lateral distance Dy error controller to determine the required steering wheel torque based on the currently measured lateral distance Dy value (e.g. the lateral distance value measured by a sensor). Here, the lateral distance Dy error controller is used to mimic the behavior or style of the driver during lane changes.

For example, when the current scenario information indicates a vehicle speed of 60 kph, a lane radius of 600 m, a lane width of 3.5 m and a rainy day, the parameter set of the Dy error controller is calculated based on relevant driver lane change samples. The parameter set comprises, for example, the adjustment factor of the proportional factor Kₚ, which is related to said lateral distance Dy.

In the above example, using the lateral distance Dy error controller to determine the required steering wheel torque based on the currently measured lateral distance Dy value comprises:

$$T = σ * {K}_{p} * Δ Dy + {K}_{i} * \int Δ Dy dt + {K}_{d} * \frac{Δ Dy}{dt} ,$$

wherein T represents the steering wheel torque, σ is the adjustment factor of the proportional coefficient Kₚ, Kᵢ is the integration coefficient of the PID controller, and K_{d} is the differential coefficient of the PID controller. In other words, the PID controller will use the proportional coefficient Kₚ multiplied by the adjustment factor σ to determine the torque request.

In one example, step S130 further comprises: utilizing the heading angle error controller in the PID controller to determine the required heading angle based on the currently measured heading angle. Here, the heading angle error controller is used to keep the vehicle in the correct driving direction.

In one or more examples, the vehicle's heading angle refers to the angle θ between the velocity v of the vehicle's center of mass and the x₀ axis of the ground coordinate system (x₀, y₀), where β is the lateral slip angle of the vehicle's center of mass and φ is the vehicle's yaw angle. Clearly, θ=β+φ.

It should be noted that in one or more of the above examples, the driver lane change samples may be recorded separately for different drivers. For example, when logging in with the first vehicle account A, lane change samples of the first driver are recorded. On the other hand, when logging in with the second vehicle account B, lane change samples of the second driver are recorded. The first driver's lane change samples and the second driver's lane change samples do not interfere with each other.

When subsequent logging in to the vehicle system with the first vehicle account A (i.e., when the first driver is driving the vehicle), specific lane change samples will be selected from the collection of lane change samples of the first driver based on the scenario information, so as to calculate the parameter set of the lateral distance Dy error controller and determine the required steering wheel torque based on the currently measured lateral distance Dy value as measured by sensors.

Similarly, when logging in to the vehicle system with the second vehicle account B (i.e., when the second driver is driving the vehicle), specific lane change samples will be selected from the collection of lane change samples of the second driver based on the scenario information, so as to calculate the parameter set of the lateral distance Dy error controller and determine the required steering wheel torque based on the currently measured lateral distance Dy value as measured by sensors.

Based on the scenario information and lane change recommendations, the automatic lane changing method for vehicles of the examples of the present application adjusts one or more parameters of the PID controller to mimic the driver's driving style during lane changes, such that the entire vehicle lane change process is more consistent with the driving style of the current driver.

In addition, it will be readily understood by those skilled in the art that the method 1000 for automatic lane changing of vehicles provided in one or more examples of the present application may be implemented through a computer program. For example, the computer program is included in a computer program product that implements the method 1000 for automatic lane changing of vehicles. As another example, when a computer storage medium (e.g., a USB flash drive) with which the computer program is stored is connected to a computer, running the computer program will execute the method 1000 for automatic lane changing of vehicles provided in one or more examples of the present application.

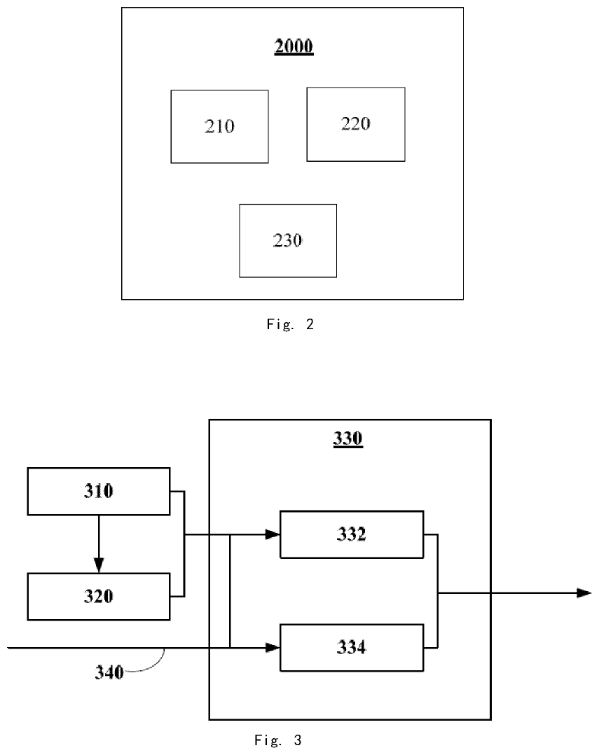

FIG. 2 shows a structural schematic diagram of a device 2000 for automatic lane changing of vehicles according to one example of the present application. As shown in FIG. 2, the device 2000 for automatic lane changing of vehicles comprises a scenario analysis module 210, a lane change recommendation module 220, and an adaptive PID control module 230. Among them, the scenario analysis module 210 is used to determine scenario information; the lane change recommendation module 220 is used to provide lane change recommendations; the adaptive PID control module 230 is used to adjust one or more parameters of the PID control module based on the scenario information and the lane change recommendations to mimic the driving style of the driver during lane changes.

In the context of the present application, “scenario information” is used to indicate the driving scenario in which the current vehicle is located. For example, when it is raining, a driver will change lanes differently than on a sunny day. Therefore, the wiper signal may be used as scenario information to adjust one or more parameters of the adaptive PID control module 230. In addition to weather, scenario information may further comprise: vehicle speed, lane radius and lane width. In one example, scenario information is indicated by a combination of wiper signal, wheel speed signal, and related information detected by other sensors.

The term “lane change recommendations” is used to indicate the use of specific driver lane change samples in a scenario. “Driver lane change samples” refer to driving information collected during the vehicle's lane change process. In one example, the driver lane change samples may be as shown in FIG. 4, which record the driver's steering wheel torque and the associated lateral distance Dy value (i.e., the lateral distance from the centerline of the adjacent lane that the vehicle is leaving (or changing to)) for each cycle during the vehicle's lane change process.

FIG. 3 shows a schematic diagram of the interaction between the various modules of the device for automatic lane changing of vehicles according to one example of the present application. As shown in FIG. 3, the scenario analysis module 310 provides the analyzed scenario information to the lane change recommendation module 320 and the lateral distance Dy error control module 332 in the adaptive PID control module 330. The lane change recommendation module 320 also provides lane change recommendations (e.g., in the case of XXX, using YYY samples for control) to the lateral distance Dy error control module 332 in the adaptive PID control module 330.

With continued reference to FIG. 3, the current measurements 340 of the sensors are separately provided to the lateral distance Dy error control module 332 in the adaptive PID control module 330 and the heading angle error control module 334. For example, the currently measured lateral distance Dy value is provided to the lateral distance Dy error control module 332 to facilitate the determination of the required steering wheel torque based on the currently measured lateral distance Dy value by the lateral distance Dy error control module 332. As another example, a heading angle error control module 334 is used to determine the required heading angle based on the currently measured heading angle.

In one example, the adaptive PID control module 330 is configured to determine specific driver lane change samples based on the scenario information and the lane change recommendations. The lateral distance Dy error control module 332 is used to calculate the parameter set thereof based on the specific driver lane change samples and to determine the required steering wheel torque based on the currently measured lateral distance Dy value.

The parameter set of the lateral distance Dy error control module 332 comprises an adjustment factor for the proportional coefficient Kₚ of the adaptive PID control module 330, with the adjustment factor related to the lateral distance Dy, and the lateral distance Dy error control module 332 is configured to determine the required steering wheel torque T based on the following formula:

$$T = σ * {K}_{p} * Δ Dy + {K}_{i} * \int Δ Dy dt + {K}_{d} * \frac{Δ Dy}{dt} ,$$

wherein σ is the adjustment factor of the proportional coefficient Kₚ, Kᵢ is the integration coefficient of the adaptive PID control module 330, and K_{d} is the differential coefficient of the adaptive PID control module 330.

In one example, the adaptive PID control module 330 further comprises: a heading angle error control module 334 used to determine the required heading angle based on the currently measured heading angle.

It should be noted that the device for the automatic lane changing of vehicles shown in FIG. 2 and FIG. 3 may be used in various types of autonomous or assisted driving systems.

In summary, based on the scenario information and lane change recommendations, the automatic lane changing solution for vehicles of the examples of the present application involves adjusting one or more parameters of the PID controller to mimic the driver's driving style during lane changes, such that the entire vehicle lane change process appears more human-controlled (i.e., performed under the control of the current driver), which enhances the comfort of vehicle driving. The solution does not require complex algorithms to plan a trajectory. The only target trajectory is the centerline of the target lane.

The automatic lane changing solution for vehicles of the examples of the present application analyzes the driver's steering wheel torque and then calculates a set of PID control parameters based on Dy to ensure that the system control provides a driving experience consistent with that under the owner's control. In one or more examples, the PID controller has learning and adaptive capabilities. Such a PID mechanism makes it possible to dynamically change the PID control parameters, making it more like a human-controlled PID control system.

The above examples primarily illustrate the automatic lane changing solution for vehicles of the examples of the present application. Although only some of the embodiments of the present application have been described, it should be understood by those with ordinary skill in the art that the present application may be implemented in various other forms without departing from its spirit and scope. Therefore, the examples and embodiments presented are illustrative rather than limiting, and the present application may encompass various modifications and replacements without departing from the spirit and scope defined by the various claims.

1. A method for automatic lane changing of vehicles, comprising:
receiving scenario information;
receiving lane change recommendations; and
adjusting one or more parameters of a PID controller based on the scenario information and the lane change recommendations to mimic driving style of a driver during lane changes.

2. The method according to claim 1, wherein the lane change recommendations instruct the use of specific driver lane change samples based on the scenario information.

3. The method according to claim 2, wherein the driver lane change samples record the driver's steering wheel torque and the associated lateral distance Dy value for each cycle during the vehicle's lane change process.

4. The method according to claim 1, wherein the scenario information is indicated at least by a wiper signal.

5. The method according to claim 3, wherein, based on the scenario information and the lane change recommendations, adjusting one or more parameters of the PID controller to mimic the driving style of the driver during lane changes comprises:
determining specific driver lane change samples based on the scenario information and the lane change recommendations;
calculating a parameter set for a lateral distance Dy error controller in the PID controller based on the specific driver lane change samples; and
using the lateral distance Dy error controller to determine the required steering wheel torque based on the currently measured lateral distance Dy value.

6. The method according to claim 5, wherein, based on the scenario information and the lane change recommendations, adjusting one or more parameters of the PID controller to mimic the driving style of the driver during lane changes further comprises:
utilizing a heading angle error controller in the PID controller to determine the required heading angle based on the currently measured heading angle.

7. The method according to claim 5, wherein the parameter set of the lateral distance Dy error controller comprises an adjustment factor for a proportional coefficient Kₚ of the PID controller, with the adjustment factor related to the lateral distance Dy.

8. The method according to claim 7, wherein, using the lateral distance Dy error controller to determine the required steering wheel torque based on the currently measured lateral distance Dy value comprises:
$$T = σ * {K}_{p} * Δ Dy + {K}_{i} ⋆ \int Δ Dy dt + {K}_{d} * \frac{Δ Dy}{dt} ,$$
wherein T represents the steering wheel torque, σ is an adjustment factor of a proportional coefficient Kₚ, Kᵢ is an integration coefficient of the PID controller, and K_{d} is a differential coefficient of the PID controller.

9. A device for automatic lane changing of vehicles, comprising:
a scenario analysis module configured to determine scenario information;
a lane change recommendation module configured to provide lane change recommendations; and
an adaptive PID control module configured to adjust one or more parameters of the PID control module based on the scenario information and the lane change recommendations to mimic driving style of a driver during lane changes.

10. The device according to claim 9, wherein the lane change recommendations instruct the use of specific driver lane change samples based on the scenario information, and wherein, the driver lane change samples record the driver's steering wheel torque and the associated lateral distance Dy value for each cycle during the vehicle's lane change process.

11. The device according to claim 9, wherein the scenario information is indicated at least by a wiper signal.

12. The device according to claim 10, wherein the adaptive PID control module is configured to determine specific driver lane change samples based on the scenario information and the lane change recommendations, and the adaptive PID control module further comprises:
a lateral distance Dy error control module used to calculate the parameter set thereof based on the specific driver lane change samples and to determine the required steering wheel torque based on the currently measured lateral distance Dy value.

13. The device according to claim 12, wherein the adaptive PID control module further comprises: a heading angle error control module configured to determine the required heading angle based on the currently measured heading angle.

14. The device according to claim 12, wherein the parameter set of the lateral distance Dy error control module comprises an adjustment factor for a proportional coefficient Kₚ of the adaptive PID control module, with the adjustment factor related to the lateral distance Dy, and the lateral distance Dy error control module is configured to determine the required steering wheel torque T based on the following formula:
$$T = σ * {K}_{p} * Δ Dy + {K}_{i} * \int Δ Dy dt + {K}_{d} * \frac{Δ Dy}{dt} ,$$
wherein σ is an adjustment factor of a proportional coefficient Kₚ, Kᵢ is an integration coefficient of the adaptive PID control module, and K_{d} is a differential coefficient of the adaptive PID control module.

15. A computer storage medium, which comprises instructions that, when executed, perform the method according to claim 1.

16. A computer program product comprising a computer program, which, when executed by a processor, performs the method according to claim 1.
